(19) United States
(12) Patent Application Publication
(10) Pub. No.: US 2025/0181375 A1
(43) Pub. Date: Jun. 5, 2025

(54) CLOUD SERVICE IMPLEMENTATION METHOD AND APPARATUS

(71) Applicant: Beijing Volcano Engine Technology Co., Ltd., Haidian District, Beijing (CN)

(72) Inventors: Huahui YANG, Beijing (CN); Xin KUO, Beijing (CN); Hui CHEN, Beijing (CN)

(21) Appl. No.: 18/840,888

(22) PCT Filed: May 22, 2023
(86) PCT No.: PCT/CN2023/095439

§ 371 Date: Aug. 22, 2024

(30) Foreign Application Priority Data
Jun. 22, 2022 (CN) 202210714376.3

(51) Int. Cl. G06F 9/455; G06F 8/61

(52) U.S. Cl. CPC G06F 9/45558; G06F 8/63; G06F 2009/45562

(57) ABSTRACT

The present disclosure relates to a cloud service implementation method. The method includes: generating an application instance corresponding to a target service in response to a service request from a client; creating, in the application instance, an initialization container according to a first basic mirror image, starting the initialization container, and writing a binary executable file in the first basic mirror image into a shared directory disc corresponding to the application instance; creating, in the application instance, an application container based on an application mirror image, reading the binary executable file from the shared directory disc, and injecting the binary executable file into the application container; running the binary executable file in the application container, to start a RuntimeAgent process; and calling the RuntimeAgent process to control a runtime process in the application instance to execute a file in the application mirror image, to process the service request.

### CROSS-REFERENCE TO RELATED APPLICATIONS

The present disclosure is based on and claims the priority to the Chinese Patent Application No. 202210714376.3 filed on Jun. 22, 2022, the present disclosure of which is incorporated by reference herein in its entirety.

### TECHNICAL FIELD

The present disclosure relates to the technical field of cloud computing, and in particular, to a cloud service implementation method and apparatus.

### BACKGROUND

A large number of concepts in the XaaS form have appeared in the cloud computing era, such as Infrastructure as a Service (IaaS), Platform as a Service (PaaS), Software as a Service (SaaS), and they all try to abstract various software and hardware resources into a kind of service for developers to use, so that developers can concentrate more on service logic without paying attention to infrastructure.

Among them, Function-as-a-Service (FaaS) is made based on the idea of Serverless computing (Serverless), and is an advanced cloud computing product at present. FaaS provides a brand-new system architecture for an application running in the cloud, and the Faas, by deploying function code provided by users, triggers the function code to execute through an event mechanism.

### SUMMARY

The present disclosure provides a cloud service implementation method and apparatus.

In a first aspect, some embodiments of the present disclosure provide a cloud service implementation method, comprising: generating an application instance corresponding to a target service in response to a service request sent from a client; wherein the target service is a cloud computing service requested by the service request; creating, in the application instance, an initialization container according to a first basic mirror image, then starting the initialization container, and writing a binary executable file in the first basic mirror image into a shared directory disc corresponding to the application instance; creating, in the application instance, an application container based on a corresponding application mirror image, reading the binary executable file from the shared directory disc, and injecting the binary executable file into the application container, wherein the application mirror image is obtained based on a native application uploaded to a cloud computing system by a user, and the native application comprises function code corresponding to the target service and configuration information of configuration items corresponding to the target service; running the binary executable file in the application container, to start a runtime agent process; and calling the runtime agent process to control a runtime process in the application instance to execute a file in the application mirror image, to process the service request.

In a second aspect, the present disclosure provides a cloud service implementation apparatus, comprising: an instance generating module, configured to generate an application instance corresponding to a target service in response to a service request sent from a client, wherein the target service is a cloud computing service requested by the service request; a first processing module, configured to create, in the application instance, an initialization container according to a first basic mirror image, then start the initialization container, and write a binary executable file in the first basic mirror image into a shared directory disc corresponding to the application instance; a second processing module, configured to create, in the application instance, an application container based on a corresponding application mirror image, read the binary executable file from the shared directory disc and inject the binary executable file into the application container, wherein the application mirror image is obtained based on a native application uploaded to a cloud computing system by a user, and the native application comprises function code corresponding to the target service and configuration information of configuration items corresponding to the target service; a running module, configured to run the binary executable file in the application container, to start a runtime agent process; and call the runtime agent process to control a runtime process in the application instance to execute a file in the application mirror image, to process the service request.

In a third aspect, the present disclosure provides an electronic device comprising a memory configured to store computer program instructions; and a processor configured to execute the computer program instructions, to cause the electronic device to implement the cloud service implementation method of the first aspect and any item of the first aspect.

In a fourth aspect, the present disclosure provides a readable storage medium comprising: computer program instructions; at least one processor of an electronic device executing the computer program instructions, to cause the electronic device to implement the cloud service implementation method of the first aspect and any item of the first aspect.

In a fifth aspect, the present disclosure provides a computer program product, which is executed by an electronic device, to cause the electronic device to implement the cloud service implementation method of the first aspect and any item of the first aspect.

### BRIEF DESCRIPTION OF THE DRAWINGS

The accompanying drawings, which are incorporated in and constitute a part of this specification, illustrate embodiments consistent with the present disclosure and together with the description, serve to explain the principles of the present disclosure.

In order to more clearly illustrate the embodiments of the present disclosure or technical solutions in the related art, the drawings used in the description of the embodiments or the related art will be briefly described below, and it is obvious for those skilled in the art to obtain other drawings without creative labor.

FIG. 1 is an overall architecture diagram of a cloud computing system provided by some embodiments of the present disclosure;

FIG. 2 is a schematic flow chart diagram of a cloud service implementation method provided by some embodiments of the present disclosure;

FIG. 3 is a schematic diagram illustrating a start sequence of containers in an application instance provided by the present disclosure;

FIG. 4 is a schematic diagram illustrating a difference between the framework of the existing FaaS-enabled user application and that of the FaaS-enabled user application in the present disclosure, provided by some embodiments of the present disclosure;

FIG. 5 is a schematic diagram of a data call link and a traffic call link provided by some embodiments of the present disclosure;

FIG. 6 is a schematic diagram of an overall framework after decoupling a data call link and a traffic call link, provided by some embodiments of the present disclosure;

FIG. 7 is a schematic architecture diagram of a cloud computing system supporting multiple protocols provided by some embodiments of the present disclosure;

FIG. 8A is a schematic flowchart of a cloud service implementation method according to FIG. 7 provided by some embodiments of the present disclosure;

FIG. 8B is a schematic flowchart of a cloud service implementation method according to FIG. 7 provided by some other embodiments of the present disclosure;

FIG. 9 is a schematic diagram of a data packet structure of an HTTP protocol provided by some embodiments of the present disclosure;

FIG. 10 is a schematic diagram of a multi-link multiplexing structure of an HTTP protocol provided by some embodiments of the present disclosure;

FIG. 11 is a framework diagram of a data call link for HTTP requests in FaaS, provided by some embodiments of the present disclosure;

FIG. 12 is a block diagram of a data call link for HTTP requests and gRPC requests in FaaS, provided by some embodiments of the present disclosure;

FIG. 13 is a schematic diagram illustrating a flexible hierarchical implementation of a Thrift framework, provided by some embodiments of the present disclosure;

FIG. 14 is a schematic diagram of a data packet structure of a second specified communication protocol, provided by some embodiments of the present disclosure;

FIG. 15 is a framework diagram of a data call link in FaaS that processes HTTP requests, gRPC requests, and Thrift requests concurrently, provided by some embodiments of the present disclosure;

FIG. 16 is a schematic diagram of a framework for performing protocol conversion on a service request, provided by some embodiments of the present disclosure;

FIG. 17 is a schematic structural diagram of an event trigger component in FaaS, provided by some embodiments of the present disclosure;

FIG. 18 is a schematic structural diagram of a cloud service implementation apparatus provided by the present disclosure;

FIG. 19 is a schematic structural diagram of an electronic device provided by the present disclosure.

### DETAILED DESCRIPTION

In order that the above objects, features and advantages of the present disclosure may be more clearly understood, aspects of the present disclosure will be further described below. It should be noted that, without conflicts, the embodiments of the present disclosure and features in the embodiments may be combined with each other.

In the following description, numerous specific details are set forth in order to provide a thorough understanding of the present disclosure, but the present disclosure may be practiced in other ways different from those described herein; it is obvious that the embodiments disclosed in the specification are only part of the embodiments of the present disclosure, and not all embodiments.

Exemplarily, taking a cloud computing system FaaS as an example, the current FaaS cannot meet the following service requirements.

1. High transformation cost: during the service development process, the event-type FaaS function requires users to adapt to Runtime of different languages of FaaS, the original service logic is abstracted into asynchronous message handler of FaaS, so that a service team has no motivation to make application migration.

2. Inadequate multi-language support: the Runtime of FaaS limits the language selection of the user, and cannot cover some less-used language scenarios, resulting in insufficient multi-language support by FaaS.

3. High user learning cost: the original intention of FaaS to provide users with a function handler interface is to reduce the user's development iteration cost, however, during the FaaS service development process, a user needs to learn how to use the handler interface provided by FaaS for the user, so that the FaaS service development increases the learning cost of the user.

4. Difficult to align with internal service governance systems: the framework itself provides users with a series of capabilities, such as scaffolding code generation and service governance, monitoring, logging, operation and maintenance. Some of the capabilities and frameworks provided by the FaaS platform overlap with service governance systems of the service mesh (MESH) architecture, and cannot be aligned. This makes it impossible for the users to integrate applications running on FaaS with the service monitoring governance system (i.e., MESH).

5. RPC (Remote Procedure Call) protocol support: based on HTTP triggers, FaaS can well cover most HTTP online service scenarios, and develop front-end services and back-end Rsetful API. However, from the perspective of a back-end service, the back-end traffic transferred by the RPC protocol cannot be met, therefore, in the long term, there must be some breakthroughs for supporting multi-protocol in Serverless/FaaS scenarios.

Based on the above analysis, the improvements on determining FaaS supported micro-services comprise the following aspects.

1. How to support a user to migrate various types of native applications (such as HTTP framework, RPC protocol and framework, and service with load-dependence) and realize low-cost Serverless of services.

2. Based on the Serverless of the native application, existing event sources (message queues, timers, database Binlog, etc.) are docked with the service to provide additional functional advantages.

3. Iteration is carried out based on a uniform FaaS architecture, and like the event-type FaaS function, it provides complete cold start and automatic scaling capacities, saving service and resource costs for service parties and further reducing costs and increasing efficiency.

The present disclosure provides a cloud service implementation method and apparatus, and a cloud computing system, wherein the cloud computing system implements the support of the cloud computing system for native applications by adopting user-defined application mirror images; and injects the required dependencies into the application mirror images by means of an initialization container, solving the binary injection problem of the runtime agent caused by the release of the user-defined mirror image, and ensuring that the application instance corresponding to the cloud computing service developed by the user can be started normally; in addition, the cloud computing system provided by the present disclosure does not make invasive modification to the user's original application mirror images during the construction phase. And the method provided by the present disclosure can support native applications developed in various languages, and will not increase the user's learning and development cost. By supporting the native applications by the cloud computing system, users can develop applications in various development frameworks without the need of restricting development languages and development environments, and the users do not need to learn the handler interface provided by the cloud computing system, greatly reducing the user's learning cost. Moreover, this can fully retain the cold start capability and the automatic scaling capacities.

In addition, the present disclosure, by decoupling the data call link and the traffic call link, and converging the adaptive transformation of multiple protocols into the data call link after the decoupling, completes support of the cloud computing system for the multiple protocols. The present disclosure also completes the migration of stock services by performing protocol conversion on service requests of specified communication protocols, so that they can meet communication protocol requirements specified by the cloud computing system. The present disclosure also ensures that the multi-protocol service requests can be correctly responded by transforming the trigger component, so that they meet event triggering of multi-protocol service requests. By port addition, protocol conversion adaptation, and transformation of the trigger component, the support of the cloud computing system for multiple protocols is realized, greatly meeting user requirements. And it is docked with the existing event sources.

The cloud computing system and cloud service implementation method provided by the present disclosure will be described in detail below through the following specific embodiments.

FIG. 1 is an overall architecture diagram of a cloud computing system provided in the present disclosure. Referring to FIG. 1, the cloud computing system shown in FIG. 1 can be, but is not limited to, FaaS, which is taken as an example herein. It is assumed that FaaS deployed for a certain area can comprise one or more central computer rooms, each central computer room can have one or more function service clusters, each function service cluster can comprise one or more service nodes, and each service node is respectively used to provide one or more cloud computing services, and therefore, the service node can also be understood as a computing node; the client can send a service request to call a cloud computing service deployed in the cloud computing system, wherein service structures of different central computer rooms can be basically consistent, and share loads such as computation, storage and network according to corresponding access layer traffic ratios, and the different central computer rooms can also form a mutual backup disaster recovery system.

From the perspective of data access and data source, the following types of triggers can be included.

1. Load Balance online traffic, such as front-end calls, internal tool API calls, etc.

2. Service Mesh call traffic, which typically carries call traffic between micro-services.

3. Message queue call traffic, which carries message processing traffic of online and offline message queues inside FaaS, and also, as an underlying channel, carries message processing such as database binary log (binlog) and object storage events and the like.

4. Timer call traffic, which is responsible for timer-related call traffic constructed based on FaaS.

Therefore, in FaaS provided in some embodiments of the present disclosure, a trigger component is comprised, and the trigger component comprises: a load balance processor, a message queue trigger, a timing trigger, and the like.

In addition, since FaaS is a platform for carrying applications, it also comprises constructing and publishing component, and meanwhile, and builds observability tools and panels based on Logging, Metrics, and Call chain and the like, namely a service MESH. In terms of traffic scheduling, FaaS also has Gateway and Dispatcher to perform fine computation and scheduling for traffic and concurrency.

In some embodiments, the overall architecture of FaaS can be built on the Kubernets framework, using different lightweight runtimes to carry the user's application entities in different scenarios. There is a companion process (Hostagent) on the Kubernets node, and a companion process (RuntimeAgent) in the application instance (pod), which are responsible for managing the life cycle of functions, agent function requests etc. In order to meet the requirements of low delay and high reliability of cold start in the periphery of Kubernets, an independent service Discovery component (Discovery) and a cold start pool component (WorkerManager) are built to ensure the stability and high availability of services. In addition, FaaS is an auto-scaling system, so that independent Metrics Aggregation Storage component (MAS) and Auto-scaling component (Autoscaler) were also built to construct a high-cohesion system of metrics system and scaling system.

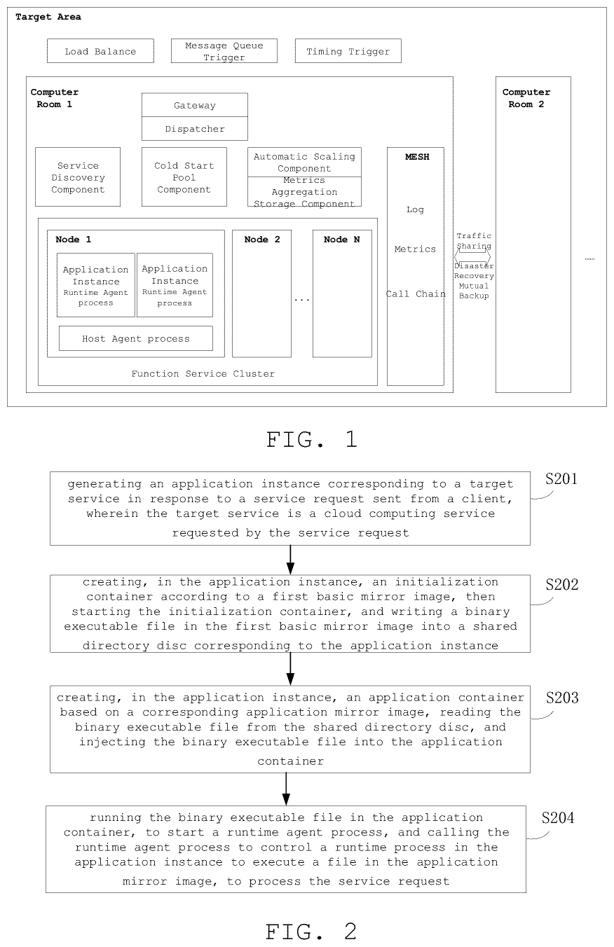

Exemplarily, through the embodiments shown in FIGS. 2 to 4, and in combination with the architecture of the cloud computing system in the embodiment shown in FIG. 1, FaaS is taken as an example to describe in detail the implementation of native application support by the cloud computing system.

The present disclosure transforms the cloud computing system, to enable it to support users to automatically define the mirror image, so that FaaS can support the native application. For example, each Runtime provided by the current FaaS corresponds to a basic mirror image, and a series of optimizations are made to cold start by separating mirror image code, but there are many limitations at the same time, one of which is that the specific dependency requirements of many user services cannot be met. For this reason, the cloud computing system provided by the present disclosure introduces a user-defined mirror image scheme to meet the user-defined dependency requirements, wherein the user-defined mirror image is an application mirror image customized by the user himself/herself, and then submitted to FaaS for deployment, and FaaS will use the application mirror image provided by the user to start the container.

Since the user-defined mirror image does not comprise a binary executable file of RuntimeAgent, and the RuntimeAgent is an indispensable process, the present disclosure, by using an initialization container on function service cluster ecology, injects the binary executable file that starts the RuntimeAgent into the user-defined mirror image.

FIG. 2 is a schematic flowchart of a cloud service implementation method provided by some embodiments of the present disclosure. Referring to FIG. 2, the method of some embodiments comprises the following steps.

The method comprises a step of S201, generating an application instance corresponding to a target service in response to a service request sent from a client, wherein the target service is a cloud computing service requested by the service request.

The client may be, but is not limited to, other cloud computing service nodes, the service request is used to request to call a target service in the cloud computing system, and as shown in FIG. 1, the target service may be pre-deployed in a target service node comprised in a certain function service cluster of the cloud computing system. When a service request sent from the client is transmitted to a corresponding function service cluster through a trigger component, a gateway, a dispatcher and other components, in response to the service request sent from the client, the target service node in the function service cluster can be called, to create in real time an application instance as an application instance in response to the service request, or schedule, from idle application instances maintained by a cold start pool component, an application instance in response to the service request.

As can be learned in conjunction with the framework shown in FIG. 1, the service request can notify the target service node to create or schedule an application instance corresponding to the service request by means of event triggering.

The method comprises a step of S202, creating, in the application instance, an initialization container according to a first basic mirror image, then starting the initialization container, and writing a binary executable file in the first basic mirror image into a shared directory disc corresponding to the application instance.

The method comprises a step of S203, creating, in the application instance, an application container based on a corresponding application mirror image, reading the binary executable file from the shared directory disc and injecting the binary executable file into the application container.

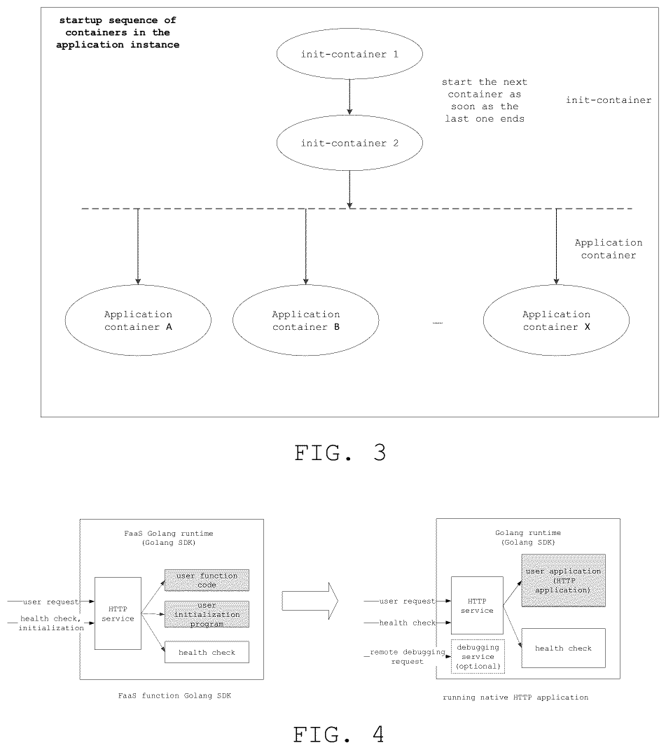

As shown in FIG. 3, the initialization container (init-container) is a special container that runs before the application container of the application instance pod is started. Init-container can include some common tools and installation scripts that do not exist in the application mirror image. There can be multiple application containers in the application instance, and applications/services uploaded and deployed by the user run in these application containers, and the application instance can have one or more init-containers that are started before the application container.

Init-containers are similar to normal containers, but with two differences: 1. always running until the end; 2. each must complete successfully before the next one can be started.

By adding the configuration of the init-container to the application instance, the init-container is started using the preset first basic mirror image, and in an init-container starting command, the binary executable file of the RuntimeAgent in the first basic mirror image is copied into the shared directory disc corresponding to the application instance; in this way, the binary executable file can be obtained in the application container, ensuring that the RuntimeAgent process can be started in the application container.

If the application instance in response to the service request is scheduled from the cold start pool component, since the idle application instances maintained in the cold start pool contain pre-started running-empty service containers without any function information, when the function (i.e., service) corresponding to the service request needs a cold start, an unused idle application instance can be obtained from the cold start pool, and then a required application mirror image is pulled and loaded from a mirror image repository to complete the cold start, to optimize the container scheduling and creation time. In a custom mirror image scenario, since it is impossible to determine which mirror image is adopted until a cold start request corresponding to the service request arrives, it can only be determined when the cold start request arrives, in order to reduce the real-time scheduling and container creation time, based on the warming pool scheme as well, the present disclosure pre-creates some running-empty service containers by adopting a preset second basic mirror image, and injects the binary executable file of RuntimeAgent into the shared directory disc by adopting the init-container mechanism, when the cold start request arrives, the second basic mirror image in the service container in the scheduled idle application instance is replaced with the application mirror image, and the idle service container is converted into an application container that can run normally by means of restart.

It should be noted that, the application mirror image in the present disclosure is obtained based on the native application uploaded by the user to the cloud computing system, and the native application is a complete application, comprising function code corresponding to the target service and configuration information of configuration items corresponding to the target service.

The native application can be developed based on any framework, and the present disclosure is not limited thereto.

The method comprises a step of S204, running the binary executable file in the application container to start a runtime agent process, and calling the runtime agent process to control a runtime process in the application instance to execute a file in the application mirror image, to process the service request.

As described above, in FaaS, the RuntimeAgent process is responsible for managing the life cycle of functions and agent function requests, etc. The RuntimeAgent process can be started by running the binary executable file injected into the application container, the runtime process (i.e., Runtime) is controlled to be started by the RuntimeAgent process, then the information of the service request is taken as an input to the function defined by the application mirror image, and the processing result of the service request can be obtained through calculation.

Some embodiments of the present disclosure implement the support of the cloud computing system for native applications by adopting user-defined application mirror images; and inject the required dependencies into the application mirror images by means of an initialization container, thereby solving the binary injection problem of the runtime agent caused by the release of user-defined mirror images, and ensuring that the application instance corresponding to the cloud computing service developed by the user can be started normally; in addition, the method of some embodiments of the present disclosure do not make invasive modifications to the user's original mirror images during the construction phase.

Based on the embodiment shown in FIG. 2, directly using the mirror image provided by the user will introduce the problem of slow cold start, OCI (open container initiative) mirror image pulling usually takes more than seconds level and may take tens of seconds when encountering a large mirror image volume, therefore, the present disclosure also needs to avoid the problem of overlong cold start time as much as possible based on the custom mirror image function.

A container is mainly composed of mirror image, isolation, and security technology, and when a container needs to be started, it is usually need to pull the complete mirror image to the local, then decompress the image, and then start the container. In the entire life cycle of the container, mirror image pulling is one of the most time-consuming steps, however, data required for starting the container generally only accounts for a small portion of the mirror image, therefore, the present disclosure can speed up container startup by loading the required data on demand when the container starts, rather than downloading the complete mirror image in advance. This can be referred to as lazy load. And the lazy load is not only applicable to cold start, but also to the startup of application containers in application instances created in real time.

In some embodiments, the target service node can pull meta-information of the application mirror image from the image repository, load the meta-information of the application mirror image into the application container created in real time, or replace the second basic mirror image of the service container of the idle application instances scheduled from the cold start pool component with the meta-information of the application mirror image, thereby obtaining the application container.

In addition, during the starting of the application container, the target service node can also call a background thread to pull data of all application mirror images to a local cache, avoiding the application container from being affected due to network jitter during the execution process thereof.

In conclusion, the starting of the application container can be accelerated by means of lazy load, and the background thread pulls the data of all application mirror images, so that the reliability of the application container during the execution process thereof can be ensured.

In addition, in combination with the description of the embodiment shown in FIG. 2, the native application (which can also be understood as an application mirror image) uploaded by the user and deployed in the cloud service system comprises configuration information of configuration items corresponding to the target service, wherein the configuration items may include but are not limited to one or more of the following.

1. Monitor port: users need to listen to a designated port, and in a Host mode shared with a host machine, the port number is dynamically injected through an environment variable. In some embodiments, each application can listen to a preset number of ports including, for example: a data port (to receive user request) and a debug port (optional).

2. Startup command: users can customize the startup command which is a finally constructed product that can be directly executed by the code package uploaded by the user when needed.

3. Health check: users can customize a health check interface, for the cloud computing system to detect the health status of the service.

4. Function lifecycle: the user service logic needs to accept the influence caused by automatic elastic scaling of the cloud computing system, and the service logic itself does not strongly depend on the status of a local operating environment.

Therefore, in the process of service development, users need to comply with one or more of the above development specifications to ensure the integrity of the application mirror image and ensure the consistency between the development environment and the running environment. It should be noted that the configuration items corresponding to the services specified in the development specifications may change with the continuous improvement of the cloud computing system. For example, as the functions of the cloud computing system are continuously improved, new configuration items appear. Or when some configuration items can be used universally, files of the universal configuration items can be deployed in the cloud computing system, and when an associated application is deployed in the cloud computing system, the files of the universal configuration items are acquired and the relevant configuration is performed.

Exemplary, please refer to FIG. 4, taking a FaaS function of a Go language (Golang) as an example, in the existing FaaS, the FaaS runtime of the Golang language is an SDK provided by the platform; a user encodes function code corresponding to a service, and uploads a binary construction product to the FaaS platform; the SDK of the actual Golang provides the user with an HTTP Server (and a predefined interface specification), after the user-encoded function code is uploaded, FaaS needs to configure and listen to various configuration items, etc.; in the existing FaaS, the FaaS function of Golang is equivalent to an HTTP service. When the development specification shown in the present disclosure is used for service development, the user uploads a complete HTTP application (as shown in the right one in FIG. 4), the complete HTTP application comprises function code as well as configuration information of a configuration item such as monitor port, startup command health check, and function life cycle self-defined and configured by the user, and FaaS can realize the running of native HTTP applications on FaaS through simple adaptation.

In conjunction with the technical solutions of the embodiments shown in FIG. 2 to FIG. 4, the cloud computing system can support native applications developed by users based on various HTTP frameworks (such as Hertz) and RPC frameworks (such as KiteX, Euler, Gulu, Archon, etc.), thereby solving the aforementioned problems of high transformation cost, insufficient multi-language support and high user learning cost of the cloud computing system.

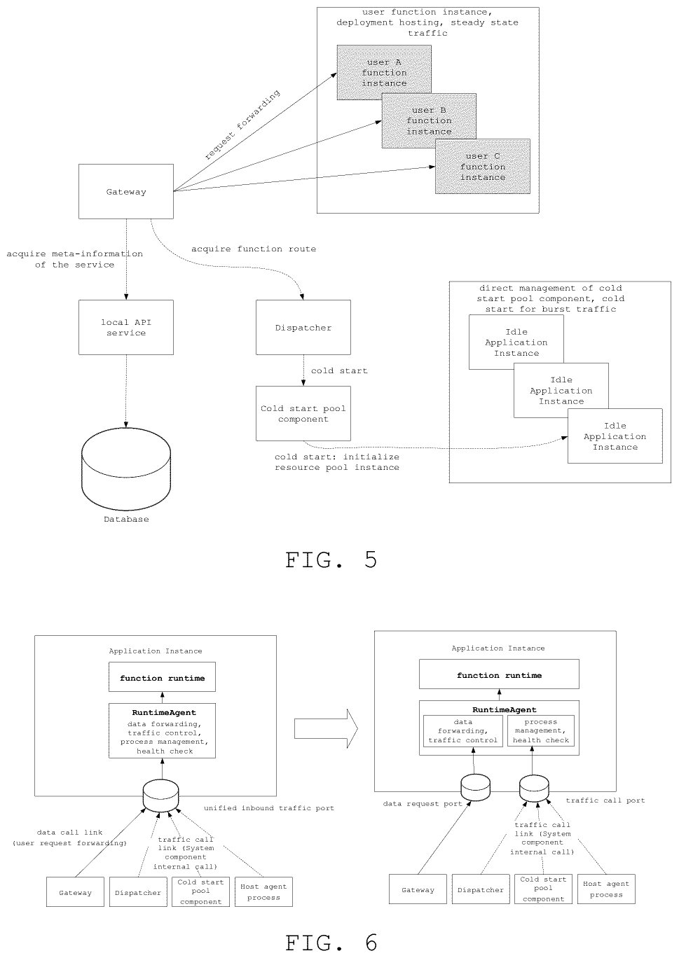

Taking FaaS as an example, on the basis that FaaS supports native applications of various protocols, it is also necessary to support service requests of multiple protocols. Exemplarily, the multi-protocol support by FaaS is described in detail through the embodiments of FIG. 5 to FIG. 17. Among them, the existing FaaS can better support service requests of the HTTP protocol, but currently cannot support service requests of multiple RPC protocols.

Currently, the existing FaaS supports the HTTP protocol, and as can be seen from analysis, the HTTP protocol can provide at least the following benefits to FaaS.

1. Multi-user request identification: delivering service meta-information based on HTTP protocol header to facilitate unified inbound traffic gateway management.

2. No need to parse the actual request body: when forwarding requests, there is no need to parse and perceive the service request body. As a 7-layer HTTP proxy, fine-grained flow control and concurrency control at the request level can be achieved.

3. Long link maintenance and multiple link multiplexing (for HTTP/2 protocol), saving resource overhead for the 7-layer proxy.

Based on the above analysis, for any network communication protocol of the application layer, if it has the above features, it can be realized as Faas.

Furthermore, by analyzing traffic and resource scheduling of Faas, the entire data plane architecture can be divided into two parts: a data call link and a traffic call link; wherein the data call link is an actual forwarding path of the service request; and the traffic call link is a call of FaaS internal components based on concurrent traffic scheduling, cold start and the like, and does not involve forwarding of the service request.

Illustratively, referring to FIG. 5, where solid arrows in FIG. 5 indicate the forwarding and transparent transmission paths of service requests, and dotted lines represent internal call links of system components involved in the traffic scheduling and cold start processes. In order to achieve multi-protocol support, the present disclosure adapts the solid links to multiple protocols, while the architecture of the dotted links remains unchanged, and the underlying traffic scheduling resource pool is shared for applications of different protocols.

The existing FaaS application instance usually provides a port for the user, and the data plane traffic agent and control plane signaling enter through a unified port. Referring to FIG. 6, in order to support multiple protocols and to further split the user data stream and FaaS control signaling, some embodiments of the present disclosure add ports for the application instance, thereby decoupling the data call and the traffic call, and decoupling logics of the data request and control signaling inside RuntimeAgent, to adapt to front-end decoupled data call port and traffic call port. After the decoupling, the adaptation transformation of the multiple protocols can be converged in the data call link, and the unified traffic scheduling capability of FaaS can be fully reused at the underlying layer.

The cloud computing system provided by the present disclosure, by decoupling the data call link and the traffic call link, presents data request ports supporting different protocols and shared traffic call ports to users, so that the Runtime and sidecar architectures can be unified in the aspect of supporting multi-protocol applications, and a set of traffic call systems can be shared at the same time. The sidecar architecture represents a bypass process attached to a service process, and can also be understood as a bypass plugin.

In combination with the above analysis, the present disclosure implements the architecture of the cloud computing system by the transformations in the following aspects, to support multiple protocols.

1. Decoupling the data call link and the traffic call link, configuring respective data request ports for multiple protocols in the data call link, and transmitting service requests of respective communication protocols to application instance of the respective communication protocols through multiple data request ports.

2. Transforming the gateway, developing and deploying gateways corresponding to the respective communication protocols based on different communication protocols. One gateway can correspond to one or more communication protocols, which is not limited in this disclosure. The present disclosure can identify and perceive the communication protocol adopted by the service request sent from the upstream client through the service MESH, determine the target gateway consistent with the communication protocol corresponding to the service request, and control the service request to be sent to the determined target gateway.

3. The gateway analyzes a request header of the received service request and determines a service request forwarding path, that is, determines to which data request port the service request is to be transmitted.

4. When the service MESH identifies that the service request is a request of a first specified communication protocol, it converts the service request of the first specified communication protocol into a service request of a second specified communication protocol, and then controls the service request of the second specified communication protocol to be transmitted to the corresponding gateway. The present disclosure does not limit the first specified communication protocol and the second specified communication protocol, the data packet structure corresponding to the first specified communication protocol may not include a request header, and the data packet structure corresponding to the second specified communication protocol may include a request header and a request frame; the protocol conversion can ensure that the service request delivered to the gateway and the application instance meets the requirements of the cloud computing system. Through protocol conversion, migration of stock services can be realized, and the needs for users to develop new service functions based on the second specified communication protocol can also be met.

5. The cloud computing system triggers a function to be executed based on an event trigger mechanism, and in order to support multiple protocols, the present disclosure configures interface definition languages of multiple different communication protocols in event triggers to support event trigger of multi-protocol service requests.

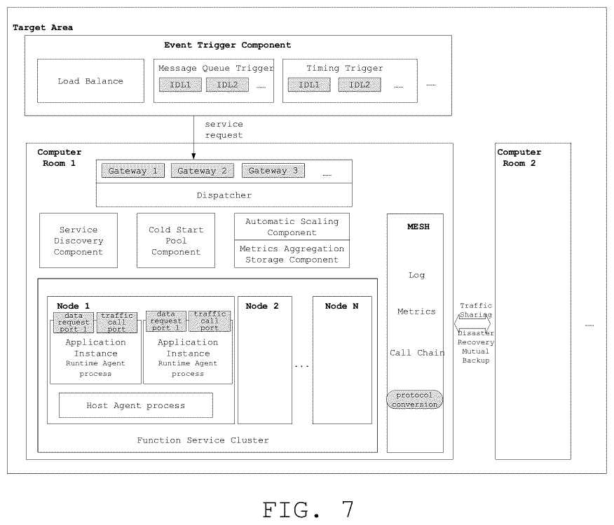

Illustratively, FIG. 7 is a schematic architecture diagram of a cloud computing system supporting multiple protocols, provided by some embodiments of the present disclosure. Referring to FIG. 7, the cloud computing system provided by some embodiments of the present disclosure further improves the event trigger component, gateway, and data stream call port, based on the cloud computing system provided by the embodiment shown in FIG. 1.

The cloud computing system provided by some embodiments of the present disclosure comprise an event trigger component, and the event trigger component comprises a variety of different event triggers, such as a load balance trigger, a timing trigger, and a message queue trigger. Each type of event trigger comprises an interface definition language of various different communication protocols, generates an event object of the service request through a function in the interface definition language, and sends the event object corresponding to the service request to a target service node in the cloud computing system, to trigger the target service node in response to the event object corresponding to the service request and generate an application instance corresponding to the target service. For example, FIG. 7 exemplarily shows that the timing trigger and the message queue trigger comprise IDL1 and IDL2 respectively, wherein IDL1 is used to generate a first type of event objects for service requests of a communication protocol 1, and IDL2 is used to generate a second type of event objects for service requests of a communication protocol 2. It should be noted that, it can be set according to the service requirements that, part or all types of event triggers support multiple protocols, and the multiple protocols supported by each type of event triggers may not be exactly the same, which can be configured flexibly.

The cloud computing system further comprises multiple gateways and service mesh nodes, wherein each gateway supports one or more corresponding communication protocols, for example, gateway 1 supports the communication protocol 1 and communication protocol 2, gateway 2 supports a communication protocol 3, gateway 3 supports a communication protocol 4, and so on, and the number of the gateways and correspondence between the gateways and the communication protocols can be set according to actual requirements.

The service mesh node can control the inbound flow of the cloud computing system. For example, the service mesh node can identify the communication protocol used by the service request sent from the client to obtain an identification result, and control the service request to be delivered to the target gateway consistent with the communication protocol adopted by the service request based on the identification result.

In addition, each application instance in the cloud computing system corresponds to the decoupled traffic call port and data request port.

The traffic call port can handle the call of internal components comprised in the cloud computing system, such as concurrent traffic scheduling and cold start of each function service cluster. In some embodiments of the present disclosure, the traffic required by the service request can be scheduled to a target service node connected to a backend through the traffic call port, to schedule the traffic required by the service request to the application instance corresponding to the service request in the target service node. Similarly, the traffic call is represented by a dotted line, and the traffic call process can refer to the embodiments shown in FIGS. 5 and 6.

The data request port is used to forward the received service request to the connected target service node, to forward the service request to the application instance corresponding to the service request in the target service node. The communication protocol supported by the data request port corresponding to each application instance is consistent with the communication protocol adopted by the corresponding service. For example, application instance 1 in node 1 corresponds to data request port 1 and traffic call port, and application instance 2 in node 1 corresponds to data request port 2 and traffic call port. If there are more application instances, the data request ports respectively corresponding to these more application instances can be connected to gateways of respective communication protocols at the front-end, and receive and forward the service requests sent from the gateway.

As described above, the gateway supporting multiple protocols can parse the request header of the service request to obtain meta-information of the service comprised in the request header, and based on the meta-information of the service, determine a target data request port corresponding to the service request from the data request ports respectively corresponding to the connected multiple application instances, and control the service request to be sent to the determined target data request port.

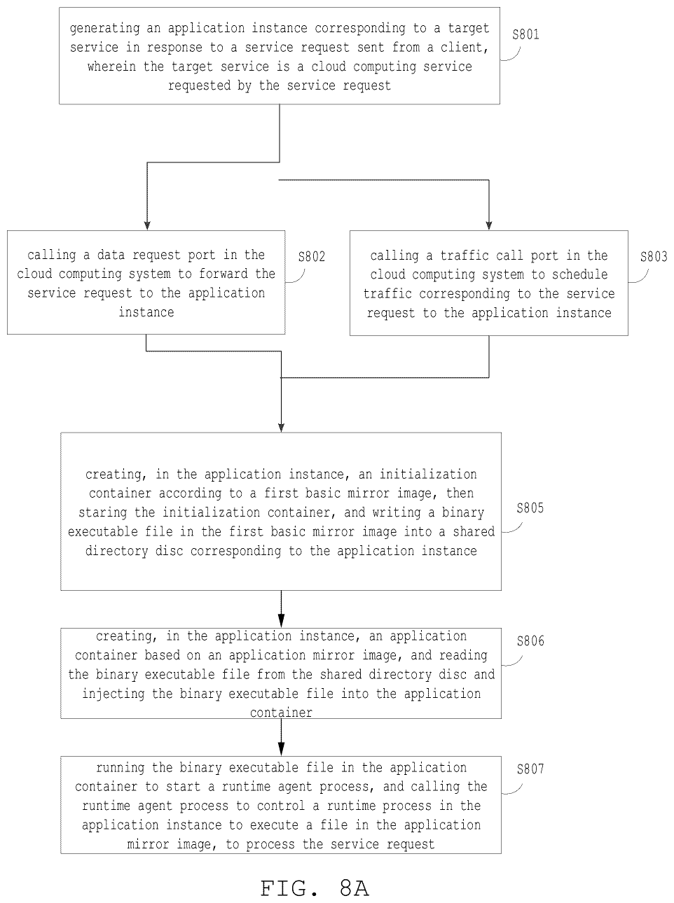

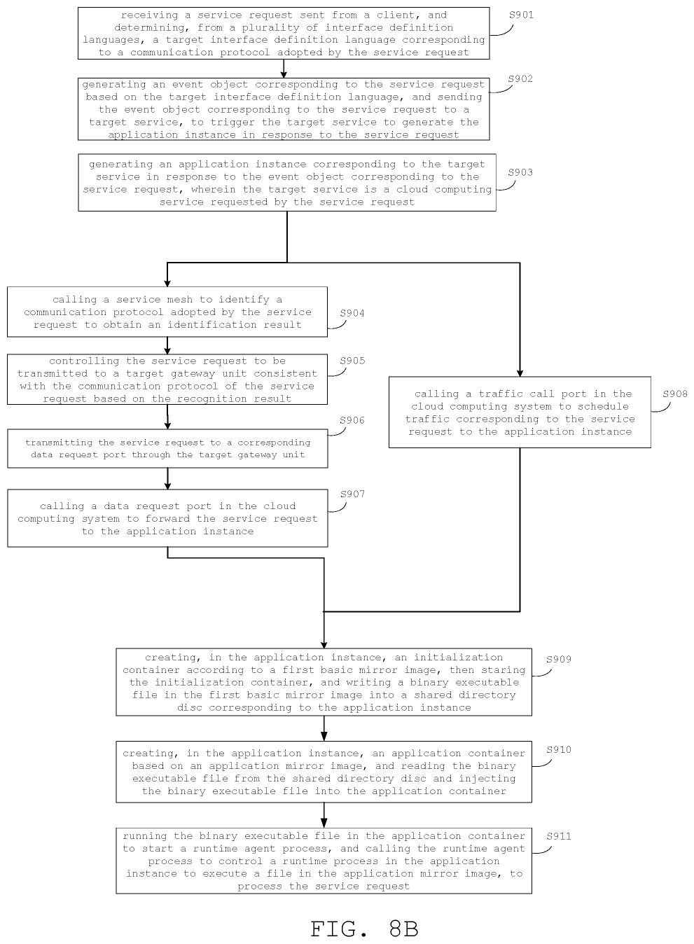

FIG. 8A is a schematic flowchart of adopting a cloud service implementation method shown in FIG. 7. Referring to FIG. 8A, the method of some embodiments of the present disclosure comprises the following steps.

The method comprises a step of S801, generating an application instance corresponding to a target service in response to a service request sent from a client, wherein the target service is a cloud computing service requested by the service request.

The method comprises a step of S802, calling a data request port in the cloud computing system to forward the service request to the application instance.

If the target gateway unit supports receiving and forwarding service requests of multiple different communication protocols, the target gateway unit parses the request header of the received service request to obtain the meta-information of the target function service, and determines the target data request port from multiple data request ports connected with the target gateway based on the meta-information of the target function service; and forwards the service request to the target data request port.

The method comprises a step of S803, calling the traffic call port in the cloud computing system to schedule the traffic corresponding to the service request to the application instance.

For example, the target function service corresponding to the service request is called, to respectively pull a first basic mirror image and an application mirror image from the image repository to a local cache, to create an initialization container and an application container.

The method comprises a step of S804, creating, in the application instance, an initialization container according to a first basic mirror image, then starting the initialization container, and writing a binary executable file in the first basic mirror image into a shared directory disc corresponding to the application instance.

The method comprises a step of S805, creating, in the application instance, an application container based on an application mirror image, and reading the binary executable file from the shared directory disc and injecting the binary executable file into the application container.

The method comprises a step of S806, running the binary executable file in the application container to start a runtime agent process; and calling the runtime agent process to control a runtime process in the application instance to execute a file in the application mirror image, to process the service request.

In some embodiments of the present disclosure, the steps S804 to S806 are similar to the steps S201 to S203 of the embodiment shown in FIG. 2, and reference can be made to the detailed description of the steps shown in FIG. 2, for the sake of brevity, they will not be repeated herein.

Some embodiments of the present disclosure provide a basis for converging multi-protocol support in a data call link by decoupling the data request port and the traffic call port, and after the decoupling, the complexity of port development can also be reduced, and it is helpful to reduce the difficulty of port maintenance and upgrade.

FIG. 8B is a flowchart of a cloud service implementation method provided by some other embodiments of the present disclosure. Referring to FIG. 8B, the method of some embodiments of the present disclosure comprises the following steps.

The method comprises a step of S901, receiving a service request sent from a client, and determining, from a plurality of interface definition languages, a target interface definition language corresponding to a communication protocol adopted by the service request.

The method comprises a step of S902, generating an event object corresponding to the service request based on the target interface definition language, and sending the event object corresponding to the service request to a target service, to trigger the target service to generate an application instance in response to the service request.

The cloud computing system triggers the application mirror images to be executed through an event trigger mechanism; as shown in FIG. 7, the cloud computing system comprises various types of event triggers, after the event trigger receives a service request sent from the client, it can select, from the plurality of interface definition languages it includes, a matching target interface definition language, to generate an event object corresponding to the service request, and send the generated event object to a target service node, to notify the target service node in response to the service request initiated by the client.

It should be noted that, the interface definition languages corresponding to different communication protocols can generate different types of event objects, which is not limited in the present disclosure.

The method comprises a step of S903, in response to the event object corresponding to the service request, generating an application instance corresponding to the target service; wherein the target service is a cloud computing service requested by the service request.

This step is similar to the step S201 in the embodiment shown in FIG. 2, and reference may be made to the detailed description of the step S201.

The method comprises a step of S904, identifying a communication protocol adopted by the service request by calling a service mesh to obtain an identification result.

The method comprises a step of S905, controlling the service request to be transmitted to a target gateway unit consistent with the communication protocol of the service request based on the identification result.

In conjunction with the embodiment shown in FIG. 7, the service mesh may perform traffic agent on the service request through a traffic agent node included therein, to identify the communication protocol adopted by the service request and perform traffic control.

The method comprises a step of S906, transmitting the service request to a corresponding data request port through the target gateway.

The target gateway obtains meta-information of the service by parsing the request header of the service request, and determines, based on the meta-information of the service, the type of communication protocol adopted by the service request, and then determines to which data request port the service request is transmitted.

In some embodiments, the communication protocol adopted by the client may not meet the requirements of the cloud computing system, for example, if a data packet structure of a service request generated by some communication protocols does not include a request body, the gateway is supported to parse the service request, and the requirements of the back-end service node for executing the service request on input data cannot be met, therefore, the client needs to be modified, but this modification is achieved through protocol conversion by the service mesh. For example, when the service mesh detects that the service request is a service request of the first specified communication protocol, the service request is converted by protocol to obtain a service request of the second specified communication protocol, and the data packet structure of the service request of the second specified communication protocol meets the requirements of the cloud computing system. The present disclosure does not limit the specific manner of the protocol conversion. By means of protocol conversion, the migration of front-end stock remote call services can be realized, meeting the service requirements of the front-end client, and not affecting the front-end client.

The method comprises a step of S907, calling a data request port in the cloud computing system to forward the service request to the application instance.

The method comprises a step of S908, calling a traffic call port in the cloud computing system to schedule traffic corresponding to the service request to the application instance.

The method comprises a step of S909, creating, in the application instance, an initialization container based on a first basic mirror image, then starting the initialization container, and writing a binary executable file in the first basic mirror image into a shared directory disc corresponding to the application instance.

The method comprises a step of S910, creating, in the application instance, an application container based on an application mirror image, and reading a binary executable file from the shared directory disc and injecting the binary executable file into the application container.

The method comprises a step of S911, running the binary executable file in the application container to start a runtime agent process, and calling the runtime agent process to control a runtime process in the application instance to execute a file in the application mirror image to process the service request.

The steps S907 to S911 are similar to the steps S802 to S806 in the embodiment shown in FIG. 8A, and reference may be made to the detailed description of the embodiment shown in FIG. 8A.

In summary, by respectively adding interface definition languages of multiple communication protocols, deploying gateways of multiple different communication protocols, and configuring data request ports of the multiple different communication protocols in each type of event trigger of the cloud computing system, the support for multiple protocols is converged in a data call link, so that the cloud computing system has the capability to support multiple protocols, and can process service requests of the various communication protocols, which promotes the evolution of the cloud computing system towards serverless.

The following exemplarily illustrates how to implement the cloud computing system supporting multiple protocols, by taking a cloud computing system FaaS which supports the HTTP protocol, gRPC protocol, and Thrift protocol as an example.

### 1) HTTP Protocol (HTTP/2 Protocol)

Some existing FaaS are usually based on the HTTP/1.1 protocol; as traffic grows, some problems gradually emerge, for example, the rapid growth of high-concurrenct request data results in explosion in the number of data call link connections. Too many TCP connections will not only lead to too many file descriptors, but also excessive memory consumption. For example, the net/http framework of Golang allocates a memory buffer for each link, and in a high-concurrency scenario, excessive memory consumption will even cause Out Of Memory (OOM), resulting in exit of the system process.

Compared with HTTP/1.1, HTTP/2 adopts a binary protocol format and supports multiplexing of multiple links, which can further reduce system overhead caused by high-concurrent requests.

Please referring to FIG. 9, the HTTP/2 protocol divides data into smaller frames, and the frame data transmission is divided into a header frame (i.e. request header) and data frames (i.e. request body). Header information of the HTTP protocol is encapsulated into the header frame, and the request body is transmitted as a data frame. Binary coding is adopted inside each frame.

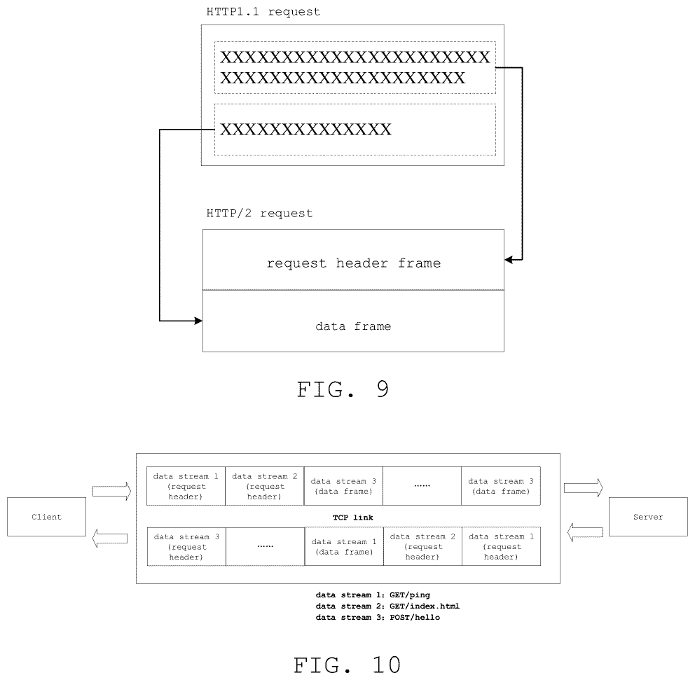

As shown in FIG. 10, after dividing the data into smaller frames, HTTP/2 can transmit multiple requests concurrently in the same TCP connection, data interaction of each request-response corresponds to an HTTP/2 data stream (stream), and different frames of different requests are distinguished by stream IDs (streamID) in the frame data. FIG. 10 exemplarily shows a scenario in which the HTTP/2 client and server transmit four concurrent requests concurrently through a same TCP connection.

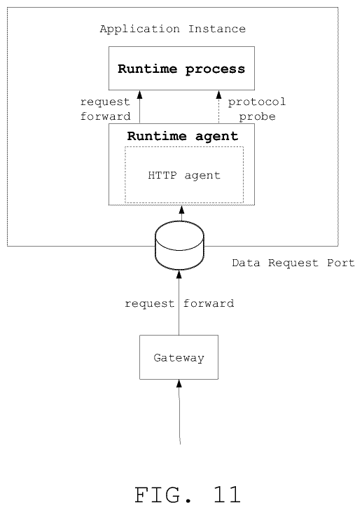

In the improvement of FaaS, because HTTP/2 is backward compatible with HTTP/1.1, the data call link agent (Gateway, RuntimeAgent) of FaaS is upgraded to HTTP/2, and in order to avoid the additional overhead introduced by TLS, the data call link internally adopts the HTTP/2 protocol without the Transport Layer Security (TLS), i.e. the H2C protocol, to transmit data in plain text format. Therefore, the transmission of the data call link for HTTP/2 in FaaS provided by the present disclosure is shown in FIG. 11.

It should be noted that some functions (i.e., services) do not support the H2C protocol when running (because the language standard library itself does not provide support for the H2C protocol, or the user used an earlier version of the SDK during development and cannot upgrade it in time), for this case, the present disclosure further employs protocol probe, such that different versions of the HTTP protocol can be flexibly compatible inside the application instance.

2) gRPC Protocol

gRPC protocol is an open source RPC protocol that supports HTTP/2 and optimizes the data call link inside the FaaS system. On the other hand it also prepares for the support of the gRPC protocol; the gRPC protocol is an open source RPC framework project, the communication protocol (transfer protocol) is based on HTTP/2, and the serialization protocol can flexibly select multiple formats such as encoding format (for example, protocol buffers, json, xml).

FaaS hopes to be able to obtain the meta-information of the service without parsing the user request body, when it is unaware of the interface definition language (IDL) of the protocol buffers request; gRPC that is based on HTTP/2 as the communication protocol meets the following requirement: a gRPC request itself can be regarded as a special HTTP/2 request, the meta-information of the service can be transmitted through the request header, and the gateway can obtain the meta-information of the service without being aware of the request body of a user, thereby realizing flow control of the request.

Compared with HTTP/2, the gRPC request has additional gRPC related fields. It should be noted that the request response comprises gprc-status (status code), and according to the gRPC specification, the status and status code of the gRPC request response depend on the gprc-status field expression and have nothing to do with the HTTP status code. Meanwhile, gprc-status is delivered to the client through a response header (Trailer Header) of the HTTP request after the request body is delivered.

In order to adapt the data call link to the gRPC request, the present disclosure is implemented in the following manner. 1. the data call links FaasGateway and RuntimeAgent make determination for the gRPC protocol, and determine the execution result of the user service logic according to the responded gRPC error code, and perform event tracking; within the maximum timeout allowed by FaaS (e.g., 15 minutes), gRPC streaming is supported; after the transformation is completed, the same set of data call links can concurrently support both HTTP and gRPC protocols. 2. The cold start resource pool separately reserves partial resources for the gRPC protocol, and based on these improvements, FaaS supports the native gRPC protocol and also supports some gRPC frameworks inside FaaS.

Illustratively, a framework of the data call link that concurrently processes HTTP requests and gRPC requests is shown in FIG. 12, where, to bind application instances of different protocols to data request ports of different communication protocols, FaasGateway distributes service requests of different communication protocols to the data request ports of respective communication protocols, and then forwards the service requests to the RuntimeAgent of the application instance through the data request port.

### 3) Thrift Protocol

Thrift is an interface description language and binary communication protocol, and is used to define and create cross-language services. It is used as a remote procedure call (RPC) framework, so it can also be understood as a special RPC protocol.

In some cases, the FaaS backend micro-service system can be built based on an internally developed protocol framework, which can be obtained by improving a certain specified open source communication protocol (an open source Thrift protocol is introduced herein). In order to support the specified communication protocol before the improvement, the following problems need to be solved.

1. The Thrift protocol is very flexible, and there are many different possibilities for layered combinations of transport layer protocols and serialized anti-sequence protocols, and it is usually difficult for FaaS to support all combinations.

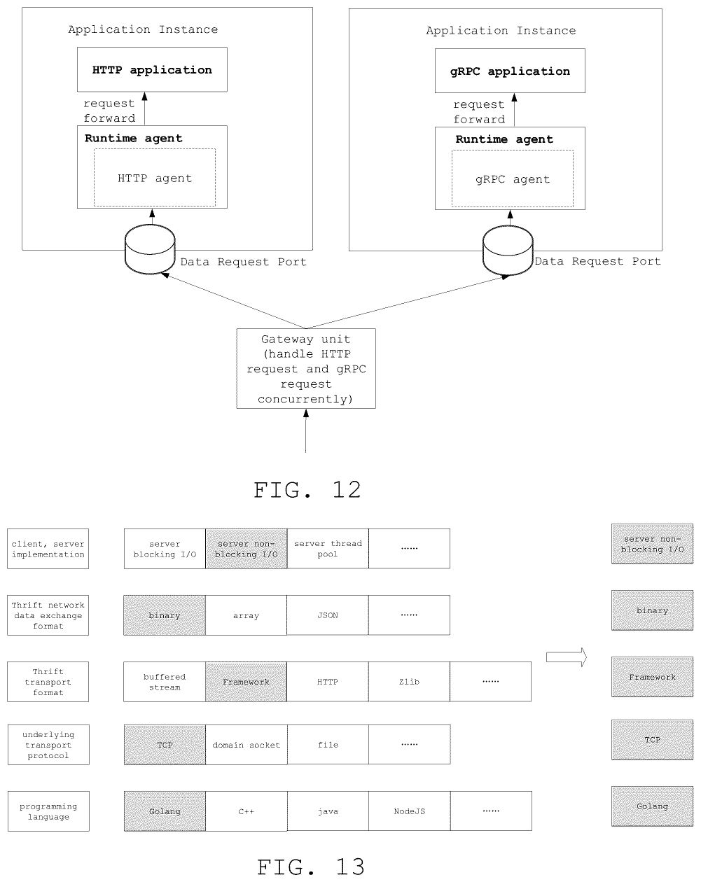

Exemplarily, reference can be made to a flexible hierarchical implementation of the Thrift framework shown in FIG. 13.

2. The native Thrift transport protocol has no request header structure like HTTP for transmitting the meta-information of the request service.

3. A data call link of the HTTP request cannot be reused like gRPC, and a new gateway agent and a data stream agent in a container need to be developed.

4. Migration of stock services: in addition to the code transformation on the server side, the migration cost of upstream clients also needs to be considered for stock services.

Based on the flexibility of the Thrift protocol, the Thrift protocol request can be converted into a unified transport protocol inside FaaS, so that the request body of the converted service request contains a request header, which can be used as a carrier for the meta-information (such as function ID) of the FaaS delivery service. Wherein the unified transport protocol inside FaaS can be generated by transformation based on (but not limited to) the Thrift protocol framework.

Illustratively, the structure of the data packet of the unified transport protocol (i.e., the second specified communication protocol) inside FaaS can be exemplarily shown in FIG. 14, which supports variable-length header content for storing the function/service meta-information required by FaaS. FIG. 14 exemplarily takes the header content length of 16 bits as an example, but it can be understood that it is not limited to 16 bits, and the length can be set according to requirements. It should be noted that the ellipsis “. . . ” in FIG. 14 indicates some fields specified by the second specified communication protocol, and the present disclosure does not limit the fields defined by the ellipsis.

For RPC requests of the Thrift protocol, Gateway (also called FaaSThriftGateway) of unified transport protocol inside FaaS and the ThriftRPC agent inside RuntimeAgent are developed and adapted. After deployment is complete, the ThriftRPC framework can be supported.

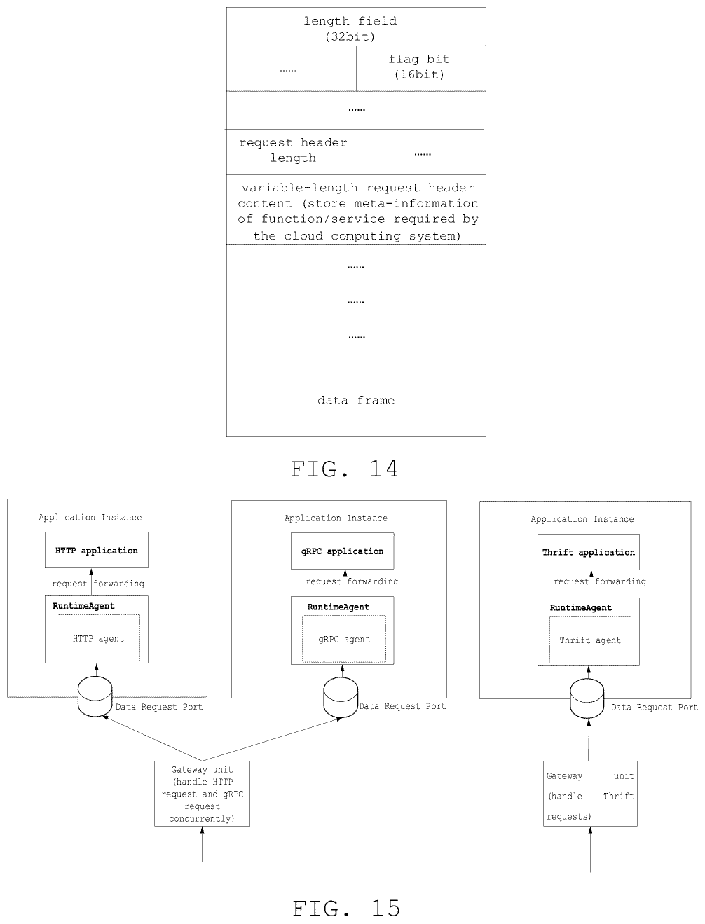

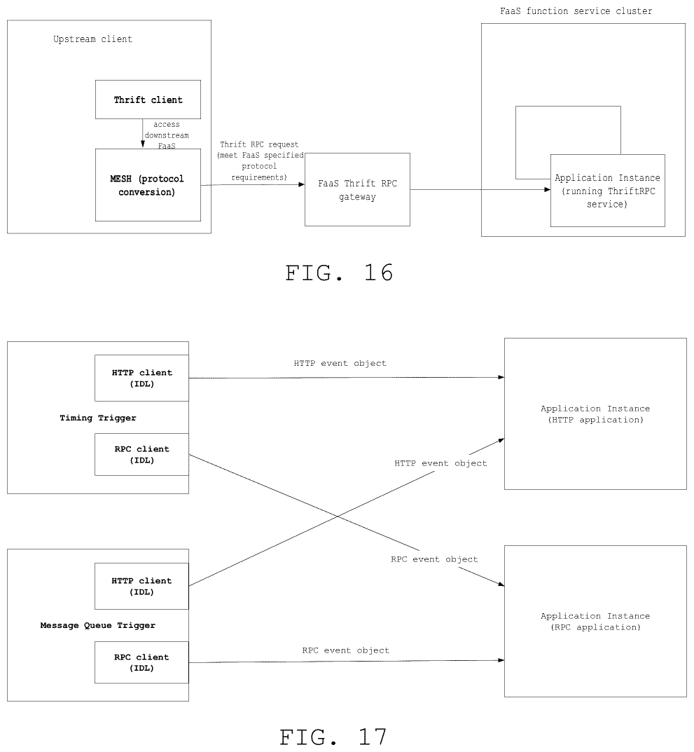

Illustratively, the framework of the data call link that concurrently processes HTTP requests, gRPC requests, and the Thrift protocol is shown in FIG. 15, where application instances of different protocols are bound to data request ports of different communication protocols, an upper layer call controls a service request to reach a FaasGateway of the corresponding communication protocol, the FaasGateway then forwards the received service request to a data request port of the corresponding communication protocol, and then forwards the service request to a RuntimeAgent of the application instance through the data request port. For example, in FIG. 16, HTTP requests and gRPC requests will be transmitted to the data request port 1 corresponding to HTTP or the data request port 2 corresponding to gRPC through FaasHTTPGateway. Thrift requests will be transmitted to the data request port 3 corresponding to Thrift through FaasThriftGateway.

It should be noted that how the service request is transmitted to the FaasGateway of the corresponding communication protocol can be controlled by the service mesh, and the service mesh can sense the service request transmitted by the upstream client, determine the gateway corresponding to each service request, and then control the transmission path of the service request. For the gateway that support multiple communication protocols, the meta-information of the function can be obtained by identifying the request header of the service request, and then the service request can be transmitted to the corresponding data request port. For example, FaasHTTPGateway can make logical judgments by identifying the request header of the service request of gRPC protocol to determine whether the service request should be distributed to the data request port 2 corresponding to gRPC, and if the service request conforms to the specification of the request header of the gRPC protocol, it is determined that the service request is distributed to the data request port 1 corresponding to HTTP.

With the above scheme, FaaS can realize the support of multiple protocols, and users can develop RPC services of different protocols based on FaaS. On this basis, a further problem that needs to be faced is a client traffic access problem, as shown in the following examples.

1. Stock service migration/client transformation problem: the framework or protocol supported by the upstream client is inconsistent with the framework or protocol supported by the downstream server, for example, the unified internal protocol supported by FaaS is inconsistent with the Thrift protocol supported by the upstream client, which will hinder the migration of the downstream server.

2. Support for event triggers in multiple protocol scenario: in a traditional event-type FaaS function scenario, users have a strong demand for event trigger access. For RPC protocol type applications, there is a need to handle online micro-service traffic and asynchronous events concurrently.

The micro-service governance system of FaaS, i.e. MESH, can perform outbound traffic agent hijacking for the outbound flow of most of clients of the online micro-service, and the agent helps users to complete operations such as downstream service discovery, monitoring dotting, current limiting and fusing. Regarding the above 1, the present disclosure uses micro-service governance system of FaaS, i.e. MESH, to perform protocol conversion for RPC accessing a downstream server. This can be implemented specifically as shown in FIG. 16.

1. The upstream client accesses the downstream FaaS service through the MESH traffic agent.

2. The MESH traffic agent can identify the type of downstream service (FaaS or PaaS) based on the downstream service information contained in the service request.

3. For the Thrift request whose downstream is FaaS, the request is converted by protocol to obtain a service request consistent with the unified transport protocol inside FaaS.

It should be noted that, in some cases, the unified transport protocol inside FaaS is an additional layer of packaging for open source specified communication protocols (such as the open source Thrift protocol), and is also a default communication protocol between some RPC clients and MESH traffic agents, therefore, the protocol conversion will not introduce too much overhead.

In order to realize the support for various RPC protocol applications, in the present disclosure, the support of the FaaS for the RPC protocol is realized by means of protocol conversion, under the conditions of not perceiving user IDL and not parsing the actual user request.

Regarding the above 2, in the HTTP protocol scenario, it is assumed that Faas uses a cloudevent event type as a unified encoding-decoding mode for HTTP requests, and in order to add an event trigger support to the RPC protocol, FaaS defines a separate event trigger IDL for RPC, and hopes that users who access the event trigger can write RPC code according to the FaaS specification, ensuring that service requests of different protocols can correctly trigger the event type, and ensuring that the service requests are correctly transmitted.

Illustratively, referring to FIG. 17, taking a timing trigger and a message queue trigger as examples, an HTTP client and an RPC client are respectively comprised in the timing trigger and the message queue trigger. The HTTP request accessing the timing trigger can generate a corresponding HTTPcloudevent through the HTTP client and transmit it to the HTTP application; the RPC request accessing the timing trigger can generate a corresponding RPC request object through the HTTP client and transmit it to the RPC application. Similarly, the HTTP request accessing the message queue trigger can generate a corresponding HTTPcloudevent through the HTTP client therein and transmit it to the HTTP application; the RPC request accessing the message queue trigger can generate a corresponding RPC request object through the HTTP client therein and transmit it to the RPC application.

Based on the above, the cloud computing system provided by the present disclosure supports users to adopt user-defined mirror image, and injects the binary executable file of the RuntimeAgent process into the user-defined mirror image by means of initialization container (init-container), ensuring that the Runtime of the application container can be started normally. In addition, when the service request adopts a cold start, the functionality of the cold start pool is reserved by replacing the mirror image in situ and triggering a restart; in addition, by means of lazy load, the startup speed of the application container is also accelerated. On this basis, the support of the cloud computing system for the native application is realized.

In addition, the present disclosure, by decoupling the data call link and the traffic call link, develops different data request ports and gateway units adapted to different communication protocols, and configures IDLs corresponding to different communication protocols in event triggers, ensuring that service requests of various communication protocols can be transmitted to the application instances of the respective communication protocols, thereby realizing FaaS support for multiple protocols.

Exemplarily, the present disclosure further provides a cloud service implementation apparatus.

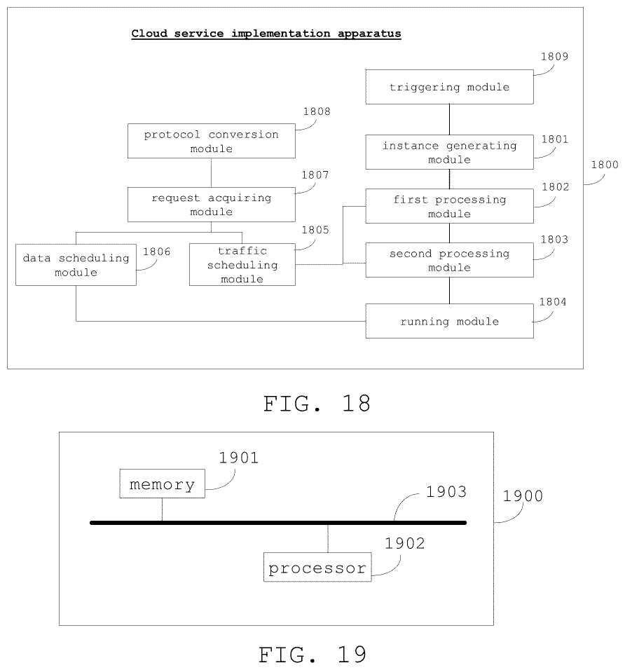

FIG. 18 is a schematic diagram of a structure of a cloud service implementation apparatus provided by some embodiments of the present disclosure. Referring to FIG. 18, an apparatus 1800 provided by some embodiments of the present disclosure comprises the following modules:
an instance generating module 1801, configured to generate an application instance corresponding to a target service in response to a service request sent from a client, wherein the target service is a cloud computing service requested by the service request;
a first processing module 1802, configured to create, in the application instance, an initialization container according to a first basic mirror image, then start the initialization container, and write a binary executable file in the first basic mirror image into a shared directory disc corresponding to the application instance;
a second processing module 1803, configured to create, in the application instance, an application container based on a corresponding application mirror image, read the binary executable file from the shared directory disc and inject the binary executable file into the application container, wherein the application mirror image is obtained based on a native application uploaded to a cloud computing system by a user, and the native application comprises function code corresponding to the target service and configuration information of configuration items corresponding to the target service; and
a running module 1804, configured to run the binary executable file in the application container, to start a runtime agent process; and call the runtime agent process to control a runtime process in the application instance to execute a file in the application mirror image, to process the service request.

In some embodiments, the instance generating module 1801 is specifically configured to, when the service request is a cold start, schedule, from a plurality of idle application instances maintained in a cold start resource pool, an idle application instance as the application instance corresponding to the target service, wherein the plurality of idle instances are created based on a second preset mirror image.

Correspondingly, the second processing module 1803 is specifically configured to replace a second basic mirror image in the service container corresponding to the idle application instance with the application mirror image, and restart to obtain the application container.

In some embodiments, the second processing module 1803 is specifically configured to pull meta-information of the application mirror image from an image repository; and create the application container based on the meta-information of the application mirror image.

In some embodiments, the configuration items corresponding to the target service comprise: one or more items of monitor port, startup command health check interface, function life cycle.

In some embodiments, the apparatus further comprises: a traffic scheduling module 1805 and a data scheduling module 1806; wherein the traffic scheduling module 1805 is configured to call a traffic call port in the cloud computing system to schedule traffic corresponding to the service request to the application instance; and the data scheduling module 1806 is configured to call a data request port in the cloud computing system to forward the service request to the application instance.

In some embodiments, the data scheduling module 1806 is specifically configured to call, from data request ports respectively corresponding to respective running application instances, a target data request port corresponding to the application instance corresponding to the service request, to forward the service request to the application instance, wherein a communication protocol supported by the target data request port is consistent with a communication protocol adopted by the service request.

In some embodiments, the apparatus further comprises: a request acquiring module 1807, configured to identify the communication protocol adopted by the service request to obtain an identification result, and based on the identification result, control the service request to be transmitted to one of a plurality of gateways that is consistent with the communication protocol of the service request, and forward the service request to a corresponding data request port through the gateway; wherein the plurality of gateways are respectively configured to forward service requests of different communication protocols.

In some embodiments, the request acquisition module 1807 is specifically configured to parse a request header of the service request by calling the gateway to obtain meta-information of the service, and determine a target data request port from a plurality of connected data request ports based on the meta-information of the service; and forward the service request to the target data request port.

In some embodiments, the apparatus further comprises a protocol conversion module 1808, configured to, when it is identified that the service request sent from the client adopts a first specified communication protocol, convert the service request of the first specified communication protocol into a service request of a second specified communication protocol.

Correspondingly, the request acquiring module 1807 is specifically configured to parse a request header of a service request of a second specified communication protocol to obtain the meta-information of the service, and determine a target data request port from a plurality of connected data request ports based on the meta-information of the service; and forward the service request to the target data request port.

In some embodiments, the apparatus further comprises: a triggering module 1809, configured to receive the service request sent from the client, and determine, from a plurality of interface definition languages, a target interface definition language corresponding to a communication protocol adopted by the service request; and generate an event object corresponding to the service request based on the target interface definition language, and send the event object corresponding to the service request to the target service, to trigger the target service to generate the application instance in response to the service request.

The modules described above may be implemented as software components executing on one or more general-purpose processors, or as hardware such as programmable logic devices and/or application-specific integrated circuits that perform certain functions or combinations thereof. In some embodiments, these modules may be embodied in the form of a software product, which may be stored in a non-volatile storage medium including instructions that cause a computer device (e.g., a personal computer, server, network device, mobile terminal, etc.) to implement the methods described in some embodiments of the present disclosure. In other embodiments, the above modules may also be implemented on a single device or distributed across multiple devices. The functions of these modules may be combined with each other, or further divided into multiple sub-modules.

The apparatuses provided in some embodiments of the present disclosure may be used to implement the technical solutions of any of the foregoing method embodiments, and their implementation principles and technical effects are similar, and for the sake of brevity, reference may be made to the detailed description of the foregoing method embodiments, and details are not described here again.

FIG. 19 is a schematic structural diagram of an electronic device provided by some embodiments of the present disclosure. Referring to FIG. 19, an electronic device 1900 provided by some embodiments of the present disclosure comprises: a memory 1901 and a processor 1902.

The memory 1901 may be an independent physical unit, and may be connected to the processor 1902 via a bus 1903. The memory 1901 and the processor 1902 may also be integrated together and implemented via hardware etc.

The memory 1901 is configured to store program instructions, and the processor 1902 calls the program instructions to execute the cloud service implementation method provided by any one of the above method embodiments.

Alternatively, when part or all of the methods of the above embodiments are implemented by software, the above electronic device 1900 may also only comprise the processor 1902. The memory 1901 for storing programs is located outside the electronic device 1900, and the processor 1902 is connected to the memory through circuits/wires for reading and executing the programs stored in the memory.

The processor 1902 may be a Central Processing Unit (CPU), a Network Processor (NP), or a combination of CPU and NP.

The processor 1902 may further comprise a hardware chip. The hardware chip may be an application-specific integrated circuit (ASIC), a Programmable Logic Device (PLD), or a combination thereof. The PLD may be a Complex Programmable Logic Device (CPLD), a field-programmable gate array (FPGA), a General Array Logic (GAL), or any combination thereof.

The memory 1901 may comprise a volatile memory, such as a random-access memory (RAM); the memory may also comprise a non-volatile memory, such as a flash memory, a hard disk drive (HDD) or a solid-state drive (SSD); the memory may also comprise a combination of the above types of memory.

The present disclosure also provides a readable storage medium comprising: computer program instructions which, when executed by at least one processor of an electronic device, cause the electronic device to implement the cloud service implementation method as provided by any of the above method embodiments.

The present disclosure also provides a computer program product, which when run on a computer, causes the computer to implement the cloud service implementation method provided by any of the above method embodiments.

The present disclosure also provides a cloud computing system comprising the cloud service implementation apparatus according to any of some embodiments of the present disclosure.

In some embodiments, the cloud computing system further comprises at least one of a traffic call port, a data request port, an event trigger, or a gateway.

The present disclosure further provides a computer program comprising: instructions that when executed by a processor, cause the processor to perform the cloud service implementation method according to any of some embodiments of the present disclosure.

It is noted that, in this document, relational terms such as “first” and “second,” and the like, are used solely to distinguish one entity or action from another entity or action without necessarily requiring or implying any actual such relationship or order between such entities or actions. Also, the terms “comprise,” “include,” or any other variation thereof, are intended to cover a non-exclusive inclusion, such that a process, method, article, or device that comprises a list of elements comprises not only those elements but also other elements not expressly listed or inherent to such process, method, article, or device. Without further limitation, an element defined by the phrase “comprising an . . . ” does not exclude the presence of other identical elements in the process, method, article, or device that comprises the element.

The above only describes specific embodiments of the present disclosure, to enable those skilled in the art to understand or implement the present disclosure. Various modifications to these embodiments will be apparent to those skilled in the art, and the general principles defined herein can be implemented in other embodiments without departing from the spirit or scope of the present disclosure. Therefore, the present disclosure will not be limited to the embodiments described herein, but will conform to the widest scope consistent with the principles and novel features disclosed herein.

What is claimed is:

1. A cloud service implementation method, comprising:
generating an application instance corresponding to a target service in response to a service request sent from a client, wherein the target service is a cloud computing service requested by the service request;
creating, in the application instance, an initialization container according to a first basic mirror image, then starting the initialization container, and writing a binary executable file in the first basic mirror image into a shared directory disc corresponding to the application instance;
creating, in the application instance, an application container based on a corresponding application mirror image, reading the binary executable file from the shared directory disc, and injecting the binary executable file into the application container, wherein the application mirror image is obtained based on a native application uploaded to a cloud computing system by a user, and the native application comprises function code corresponding to the target service and configuration information of a configuration item corresponding to the target service;
running the binary executable file in the application container, to start a runtime agent process; and
calling the runtime agent process to control a runtime process in the application instance to execute a file in the application mirror image, to process the service request.

2. The cloud service implementation method according to claim 1, wherein:
the generating an application instance corresponding to a target service in response to a service request sent from a client, comprises: scheduling, from a plurality of idle application instances which are created based on a second preset mirror image and maintained by a cold start resource pool, an idle application instance as the application instance corresponding to the target service, in response to the service request being a cold start;
the creating, in the application instance, an application container based on a corresponding application mirror image, comprises: replacing a second basic mirror image in the service container corresponding to the idle application instance with the application mirror image, and restarting to obtain the application container.

3. The cloud service implementation method according to claim 1, wherein the creating, in the application instance, an application container based on a corresponding application mirror image, comprises:
pulling meta-information of the application mirror image from an image repository; and
creating the application container based on the meta-information of the application mirror image.

4. The cloud service implementation method according to claim 1, wherein the configuration item corresponding to the target service comprises: one or more of monitor port, startup command, health check interface, or function life cycle.

5. The cloud service implementation method according to claim 1, further comprising, before the creating, in the application instance, an initialization container according to a first basic mirror image:
calling a traffic call port in the cloud computing system to schedule traffic corresponding to the service request to the application instance; and
calling a data request port in the cloud computing system to forward the service request to the application instance.

6. The cloud service implementation method according to claim 5, wherein the calling a data request port in the cloud computing system to forward the service request to the application instance, comprises:
calling, from data request ports respectively corresponding to running application instances, a target data request port corresponding to the application instance corresponding to the service request, to forward the service request to the application instance, wherein a communication protocol supported by the target data request port is consistent with a communication protocol adopted by the service request.

7. The cloud service implementation method according to claim 6, further comprising:
before the calling a data request port in the cloud computing system to forward the service request to the application instance, identifying the communication protocol adopted by the service request to obtain an identification result, and controlling the service request to be transmitted to a gate way of a plurality of gateways that is consistent with the communication protocol of the service request based on the identification result, and forwarding the service request to a corresponding data request port through the gateway, wherein the plurality of gateways are respectively configured to forward service requests of different communication protocols.

8. The cloud service implementation method according to claim 7, wherein the forwarding the service request to a corresponding data request port through the gateway, comprises:
parsing a request header of the service request through the gateway to obtain meta-information of the service, and determining a target data request port from connected data request ports based on the meta-information of the service; and
forwarding the service request to the target data request port.

9. The cloud service implementation method according to claim 7, further comprising:
before the identifying the communication protocol adopted by the service request to obtain an identification result, and controlling the service request to be transmitted to a gate way of a plurality of gateways that is consistent with the communication protocol of the service request based on the identification result, converting the service request of a first specified communication protocol into a service request of a second specified communication protocol in response to identifying that the service request sent from the client adopts the first specified communication protocol.

10. The cloud service implementation method according to claim 1, further comprising:
before the generating an application instance corresponding to a target service in response to a service request sent from the client, receiving the service request sent from the client, and determining, from multiple kinds of interface definition language, a target interface definition language corresponding to a communication protocol adopted by the service request; and
generating an event object corresponding to the service request based on the target interface definition language, and sending the event object corresponding to the service request to the target service, to trigger the target service to generate the application instance in response to the service request.

11. (canceled)

12. An electronic device comprising:
a memory configured to store computer program instructions; and
a processor configured to execute the computer program instructions, to cause the electronic device to implement a cloud service implementation method comprising:
generating an application instance corresponding to a target service in response to a service request sent from a client, wherein the target service is a cloud computing service requested by the service request;
creating, in the application instance, an initialization container according to a first basic mirror image, then starting the initialization container, and writing a binary executable file in the first basic mirror image into a shared directory disc corresponding to the application instance;
creating, in the application instance, an application container based on a corresponding application mirror image, reading the binary executable file from the shared directory disc, and injecting the binary executable file into the application container, wherein the application mirror image is obtained based on a native application uploaded to a cloud computing system by a user, and the native application comprises function code corresponding to the target service and configuration information of a configuration item corresponding to the target service;
running the binary executable file in the application container, to start a runtime agent process; and
calling the runtime agent process to control a runtime process in the application instance to execute a file in the application mirror image, to process the service request.

13. A non-transitory computer readable storage medium having thereon stored computer program instructions, which when executed by a processor, implement a cloud service implementation method comprising:
generating an application instance corresponding to a target service in response to a service request sent from a client, wherein the target service is a cloud computing service requested by the service request;
creating, in the application instance, an initialization container according to a first basic mirror image, then starting the initialization container, and writing a binary executable file in the first basic mirror image into a shared directory disc corresponding to the application instance;
creating, in the application instance, an application container based on a corresponding application mirror image, reading the binary executable file from the shared directory disc, and injecting the binary executable file into the application container, wherein the application mirror image is obtained based on a native application uploaded to a cloud computing system by a user, and the native application comprises function code corresponding to the target service and configuration information of a configuration item corresponding to the target service;
running the binary executable file in the application container, to start a runtime agent process; and
calling the runtime agent process to control a runtime process in the application instance to execute a file in the application mirror image, to process the service request.

14. (canceled)

15. The electronic device according to claim 12, wherein:
the generating an application instance corresponding to a target service in response to a service request sent from a client, comprises: scheduling, from a plurality of idle application instances which are created based on a second preset mirror image and maintained by a cold start resource pool, an idle application instance as the application instance corresponding to the target service, in response to the service request being a cold start;
the creating, in the application instance, an application container based on a corresponding application mirror image, comprises: replacing a second basic mirror image in the service container corresponding to the idle application instance with the application mirror image, and restarting to obtain the application container.

16. The electronic device according to claim 12, wherein the creating, in the application instance, an application container based on a corresponding application mirror image, comprises:
pulling meta-information of the application mirror image from an image repository; and
creating the application container based on the meta-information of the application mirror image.

17. The electronic device according to claim 12, wherein the configuration item corresponding to the target service comprises: one or more of monitor port, startup command, health check interface, or function life cycle.

18. The electronic device according to claim 12, further comprising, before the creating, in the application instance, an initialization container according to a first basic mirror image:
calling a traffic call port in the cloud computing system to schedule traffic corresponding to the service request to the application instance; and
calling a data request port in the cloud computing system to forward the service request to the application instance.

19. The non-transitory computer readable storage medium according to claim 13, wherein:
the generating an application instance corresponding to a target service in response to a service request sent from a client, comprises: scheduling, from a plurality of idle application instances which are created based on a second preset mirror image and maintained by a cold start resource pool, an idle application instance as the application instance corresponding to the target service, in response to the service request being a cold start;
the creating, in the application instance, an application container based on a corresponding application mirror image, comprises: replacing a second basic mirror image in the service container corresponding to the idle application instance with the application mirror image, and restarting to obtain the application container.

20. The non-transitory computer readable storage medium according to claim 13, wherein the creating, in the application instance, an application container based on a corresponding application mirror image, comprises:
pulling meta-information of the application mirror image from an image repository; and
creating the application container based on the meta-information of the application mirror image.

21. The non-transitory computer readable storage medium according to claim 13, wherein the configuration item corresponding to the target service comprises: one or more of monitor port, startup command, health check interface, or function life cycle.
